(19) United States
(12) Patent Application Publication
(10) Pub. No.: US 2013/0207348 A1
(43) Pub. Date: Aug. 15, 2013

(54) Applicator for Sealants, Method of Combined Applying and Wiping of Sealant on a Joint Line

(71) Applicant: Rene Frederik Hendrikus Smeets, Breda (NL)

(72) Inventor: Rene Frederik Hendrikus Smeets, Breda (NL)

(73) Assignee: MACH INNOVATIVE SOLUTIONS B.V., Breda (NL)

(21) Appl. No.: 13/699,102

(22) PCT Filed: Apr. 15, 2011
(86) PCT No.: PCT/NL11/00029

§ 371 Date: Feb. 25, 2013

(30) Foreign Application Priority Data
May 20, 2010 (NL) 2004754

(51) Int. Cl. B05C 1/00

(52) U.S. Cl. CPC B05C 1/00
USPC 277/316; 401/143

(57) ABSTRACT

Applicator (1) for sealants, comprising—a feed tube (7) with a supply side (5), a tubular feed part and an outflow side, wherein the outflow side comprises a nozzle (22); —a wiping blade (9) fixedly connected to the outflow side of the feed tube, wherein the periphery of the nozzle is located in the upper surface of the wiping blade and wherein the upper surface of the wiping blade has a profile formed from: an inner surface (24) bounded by two upright dikes (20), wherein the nozzle is located between the two dikes and in the inner surface, wherein the dikes and the inner surface extend to an edge (28, 30) of the wiping blade where the profile of the inner surface (24) and the dikes (20) together form a wiping edge (28) for applying and wiping sealant on an object.

The invention relates to an applicator for sealants, consisting of a feed tube with a supply side, a tubular feed part and an outflow side, wherein the outflow side comprises a nozzle. The invention relates particularly to applying and wiping sealant on a joint line present between two surfaces, wherein the surfaces are at an angle to each other.

Much use is made of such an applicator in the building industry for applying sealants in a joint line between two surfaces. Such a joint line may for instance be present between two walls at an angle to each other, or between the surface of sanitary ware and a wall on which the sanitary ware is mounted. Depending on the specific surfaces in question, the joint line can take the form here of a straight line or a curved line.

Sealant is understood here to mean any suitable compound intended to form a sealing joint between two surfaces, such as insulating sealant, for instance on the basis of silicones or an acrylate, or specific other adhesives having a sealing and protective effect on the joint line. Characteristic of the sealant is that it is applied in plastic state (for instance as a high-viscous paste), generally dries quickly in air after application and finally forms a fixed joint after curing.

The sealant is packed for direct use in a container on which an elongate spout with a nozzle is mounted so that the compound can be injected into the joint. A mechanical pressing device is generally used here for pressing the compound in dosed manner out of the container—also referred to as a gun. Owing to the round nozzle of the spout the sealant is initially applied in the joint line in the form of a sausage.

Such a sausage shape does not yet function sufficiently as a sealing joint: the sealant has to be further treated to enable proper connection to the surfaces adjacent to the joint line. The user can for instance simply run a finger along the sealant and apply a pressure to the joint so that the sealant is pressed to some extent into the joint and spread against the adjacent surfaces. The joint is then sprayed with soap suds and irregularities or ragged edges on the longitudinal edges of the joint are then cut away. The edges can be more readily cut away through the use of soap suds. The drawback of using soap suds is that a part remains behind on the joint and there reduces the adhesion between joint and walls. Soap suds left behind moreover increase the chance of fungus formation.

Available commercially as alternative to this manual further treatment are spatula sets (from among others the company Vidcom A/S) which consist of planar spatulas which can be moved along the joint in order to obtain a desired form of the joint. Here also the longitudinal edges of the joint have to be further treated with a cutting knife and soap suds. In addition to the additional operations of wiping and further treatment to bring the joint into the correct form, it is moreover required that wiping and further treatment are performed quickly, immediately after application of the sealant, because the sealant cures quickly.

In order to obviate this problem an applicator is proposed in the U.S. Pat. No. 5,017,113 for simultaneously applying and wiping a sealant by making use of a specific spout connected to a sealant container. This spout is provided at the outer end, at the position of the nozzle, with a triangular planar squeegee. In order to apply sealant in a joint line between two mutually perpendicular surfaces, the spout with the triangular squeegee must be held such that a rounded tip of the triangle is directed at the joint line, wherein the adjoining sides are pressed against the adjacent walls. Although the joint is applied directly in a suitable form using this method, the longitudinal edges of the joint are still always irregular or ragged. This is associated with the fact that the sides of the triangle which press against the adjacent walls are somewhat flexible: as a result they follow irregularities in the wall surfaces, whereby the longitudinal edges of the joint also display irregularities. A joint is moreover obtained which comprises much material in the centre, this quantity gradually decreasing toward the longitudinal edges which comprise very little material. In other words: the longitudinal edge obtained has a very small thickness, which makes it vulnerable during normal use and maintenance: the longitudinal edge may peel off or tear easily when any force is exerted thereon. Finally, the applicator of U.S. Pat. No. 5,017,113 requires the squeegee part to bend considerably during applying of the joint; this imposes special requirements in terms of the flexibility of the squeegee part on the one hand, and the squeegee part will be more susceptible to wear on the other.

The invention has for its object to further improve the above described applicator and wholly or partially obviate the associated drawbacks.

Provided for this purpose according to a first aspect of the invention is an applicator for sealant, comprising

a feed tube with a supply side, a tubular feed part and an outflow side, wherein the outflow side comprises a nozzle;

a wiping blade fixedly connected to the outflow side of the feed tube, wherein the periphery of the nozzle is located in the upper surface of the wiping blade and wherein the upper surface of the wiping blade has a profile formed from:

an inner surface bounded by two dikes, these dikes are raised relative to the inner surface and extend at a distance from each other in the longitudinal direction of the wiping blade, wherein the nozzle is located between the two dikes and in the inner surface,

wherein the dikes and the inner surface extend to an edge of the wiping blade where the profile of the inner surface and the dikes together form a wiping edge for applying and wiping sealant on an object,

wherein the wall of the dikes rising from the inner surface is defined as inner wall, and wherein the inner walls of the dikes have a diverging orientation relative to each other at least at the position of the wiping edge in a cross-sectional view perpendicularly of the longitudinal direction of the wiping blade.

During use the applicator according to the invention is first mounted on a container for sealant. The profile of the upper surface of the wiping blade is then directed at a joint line, wherein the longitudinal direction of the wiping blade is placed in line with the joint line. It is noted in the context of the invention that the joint line is present between two adjacent surfaces at a right angle to each other, this being understood to mean that the adjacent surfaces do not lie in one plane but, relative to the joint line, form an angle to each other of less than 180 degrees.

The two dikes on the wiping blade are then brought into contact with the two surfaces adjacent to the joint line and held in this position. The sealant is then pressed out so that the sealant spreads over the inner surface of the wiping blade. The wiping blade is simultaneously moved along the joint line such that the sealant, via the inner surface and subsequently along the wiping blade, leaves the wiping blade and is herein applied and wiped in the joint line. Because of the profile of the wiping blade at the position of the wiping edge the sealant is wiped such that the joint obtained has an longitudinal edge extending away from the surfaces on which the joint is arranged.

Thus achieved is that the longitudinal edges are of some thickness, this making them more durable and so less vulnerable. The forming of raggedness or an irregular serrated edge will hereby be reduced or even wholly prevented. It is thus possible without any further treatment to form a joint which is more durable than heretofore known. The height of the inner wall of the dikes defines the thickness of the longitudinal edge of the formed joint and can be varied as desired.

The forming of a suitable longitudinal edge extending away from the surfaces on which the joint is arranged requires a diverging orientation of the inner walls of the dikes, as will become further apparent from the figures described below. This is closely associated with the fact that the applicator is intended for the purpose of applying a joint on a joint line between two surfaces at an angle to each other. The term ‘diverging’ is further elucidated in the figure description.

An additional advantage of the applicator according to the invention is that very sparing use is made of the sealant since all the material pressed out does in fact end up in the joint and no further operation is necessary in which residues are removed. A saving of 15 to 25% sealant is hereby readily achievable in respect of the quantity required in a joint. A saving of 30 to 60% sealant is moreover achieved in that longitudinal edges need not be cut off.

The applicator according to the invention is preferably manufactured from plastic material, for instance by injection moulding. The plastic material preferably has flexible qualities, such as an elastomer or a thermoplastic rubber, including PP, PE and S(E)BS. The wiping blade is particularly of flexible quality so that it can shape itself as well as possible to the joint line during use and the dikes maintain a good contact with the walls adjacent to the joint line. In this respect the feed tube is optionally manufactured from a relatively stiffer material, for instance by injection moulding with two components.

The dikes on the wiping blade are arranged at a distance from each other which, at least at the wiping edge, corresponds to the desired width of the joint to be formed. This distance is for instance about 1.0 cm. Another joint size may however be desired for other applications, with variations between for instance 0.5 and 2.0 cm. The distance between the dikes at the position of the nozzle will in any case generally be greater than the diameter of the nozzle, although variation is also possible here. The dikes are for instance arranged at a fixed distance from each other over the whole longitudinal direction and thus form a parallel track. Alternatively, the distance between the dikes can vary over the longitudinal direction, wherein the dikes together form a widening or narrowing track.

It is recommended that in the applicator according to the invention the inner walls of the two dikes are arranged such that tangents to the inner walls of the two dikes, in a cross-sectional view perpendicularly of the longitudinal direction of the wiping blade, lie at an angle relative to each other of 45 degrees to 135 degrees, preferably an angle of 90 degrees to 135 degrees.

These specific angles between the tangents to the inner walls make the applicator suitable for forming a joint with longitudinal edges extending away from the surfaces on which the joint is arranged in a joint line between two adjacent surfaces at an angle to each other of 45 degrees to 135 degrees.

For a joint line between two adjacent surfaces at an angle of 90 degrees to each other an applicator can thus be advantageously used with inner walls having a mutual diverging orientation of 90 degrees. The result will then be that the longitudinal edge of the applied joint lies perpendicularly of the adjacent walls. It can otherwise be advantageous in such a case to even apply a diverging orientation larger than 90 degrees: a joint is thus obtained with a longitudinal edge which is not perpendicular to the wall but at something of an incline, so that the transition between wall and longitudinal edge is more gradual.

The same consideration applies in similar manner for two adjacent surfaces at an obtuse angle to each other of for instance 135 degrees: in such a case an applicator with a diverging orientation of 90 degrees can be used, whereby in the same manner a joint with an obliquely longitudinal edge, extending away from the surfaces on which the joint is arranged, is obtained.

Each of the two dikes of the applicator according to the invention preferably comprises an inner wall and an outer wall, wherein the outer wall and inner wall connect to each other at a tipped top part, wherein if desired the tipped top part has a sharp, truncated or rounded tip form. The function of the top part is that when the applicator is used a good sealing contact is effected between the dikes of the applicator and the adjacent surfaces against which it is held. A good sealing contact achieves that the sealant is held inside the dikes during application thereof, and a uniform joint is thus obtained which is formed in accordance with the profile at the position of the wiping edge.

It is advantageous here for the dike to have a tipped top part because the contact surface of the dike is thereby relatively small, and the pressure which the dike exerts on the facing surface is therefore relatively great, thereby enhancing the sealing effect. This effect is enhanced with a tipped top part having a sharp tip form.

Each of the two dikes of the applicator according to the invention more preferably comprises an inner wall and an outer wall, wherein the outer walls of the dikes have a converging orientation relative to each other in a cross-sectional view perpendicularly of the longitudinal direction of the wiping blade. Such an orientation has the advantage that the wiping blade can be placed for use against a joint line without the outer walls making contact with the adjacent surfaces. Avoiding such contact between outer wall and surface achieves that only the top part of the dikes exerts a pressure on the facing surface.

It is particularly recommended in respect of the converging orientation that tangents to the outer walls of the two dikes, in a cross-sectional view perpendicularly of the longitudinal direction of the wiping blade, lie at an angle relative to each other of 90 degrees or less, preferably an angle of 70 degrees or less. This provides the above stated advantages when the surfaces adjacent to the joint line are at an angle of 90 degrees or more to each other.

According to a preferred variant of the applicator according to the invention the inner surface of the wiping blade has, at least at the position of the wiping edge, a convex form in a cross-sectional view perpendicularly of the longitudinal direction of the wiping blade. The sealant is thus applied in a suitable form during use of the applicator so that a concave joint is finally obtained, this being preferred.

According to another preferred variant of the applicator according to the invention, the dikes extend as far as the second edge of the wiping blade, this second edge forming a collecting edge for collecting excess sealant. During use of the applicator it may occur that excess sealant is pressed out which cannot immediately be spread at the wiping edge on the intended outflow side. In order to prevent undesirable buildup of pressure occurring in the sealant present in the space between the dikes, the second outer edge provides the option of allowing excess sealant to escape to some extent. As soon as the user notices this, he/she can modify the pressing speed so that no further excess is pressed out, and the excess compound can be guided back along the second outer edge to the inner surface in a continuous movement of the applicator along the joint line. The distance between the dikes advantageously increases slightly at the collecting edge. The dikes thus have a funnel function at the collecting edge, thereby further improving feedback of excess sealant which has escaped at the collecting edge.

In the applicator according to the invention the upper surface of the wiping blade more preferably lies in a tilted position relative to the feed tube, preferably at an angle of 20 to 70 degrees.

A tilted position allows the user to guide the feed tube, and thereby the container of sealant and the gun, at a slight incline along the joint, this facilitating use.

The feed part of the applicator can be embodied as a substantially straight tube which for instance tapers.

The supply side of the tube can comprise coupling means, for instance a screw thread or a clamp coupling. The coupling means can be used for coupling to an existing spout of a tube or container (as attachment) or for a direct coupling to the tube or container.

In a following variant of the applicator according to the invention the feed tube is embodied as a releasable assembly of two parts, wherein the first part comprises the supply side and the second part the outflow side. The advantage of a two-fold construction is that it is possible to combine the first part with the different embodiments of the second part, as circumstances require. In addition, the first part need not be uncoupled from the container with sealant.

The applicator according to the invention more preferably comprises a removable protective cap for the wiping blade consisting of a planar body having on a flat side a profile complementary to the profile of the upper surface of the wiping blade, wherein the profile of the protective cap is placed fitting onto the profile of the wiping blade.

Owing to the complementary profiles the protective cap and wiping blade fit closely onto each other, whereby an optimum closure is obtained. When the applicator is not in use the protective cap is placed on the upper surface of the wiping blade and keeps the upper surface free of soiling and protects it against scratches, dents etc. A perfect joint can thus be applied over a long period of time using the applicator. The protective cap is removed during use of the applicator.

The protective cap can have a periphery similar to that of the wiping blade so that it covers the whole surface without being impractically large. If desired, the protective cap can be connected to the feed tube via a cord or a flexible strip, or the protective cap can be a separate component.

Of added value in this respect is a protective cap comprising an edge with a profile complementary to the profile of the upper surface of the wiping blade in a cross-section perpendicularly of the longitudinal direction of the wiping blade. Such a profile on the edge of the protective cap can be placed as a comb perpendicularly of the profile of the upper surface and moved reciprocally over the upper surface. Residues of sealant remaining on the upper surface of the wiping blade can thus be removed or scraped off following use of the applicator so that a clean and smooth upper surface is obtained before the applicator is stored away.

Advantageously connected here to the flat side with profile of the protective cap is a pin which, when placed on the wiping blade, fits into the nozzle. The protective cap can thus be held in a fixed position on the wiping blade. The pin moreover pushes possible residues of sealant in the nozzle back into the feed tube.

Alternatively, the protective cap can be pushed onto the wiping blade by means of slide connections.

The invention will be further elucidated hereinbelow with reference to the accompanying figures, in which:

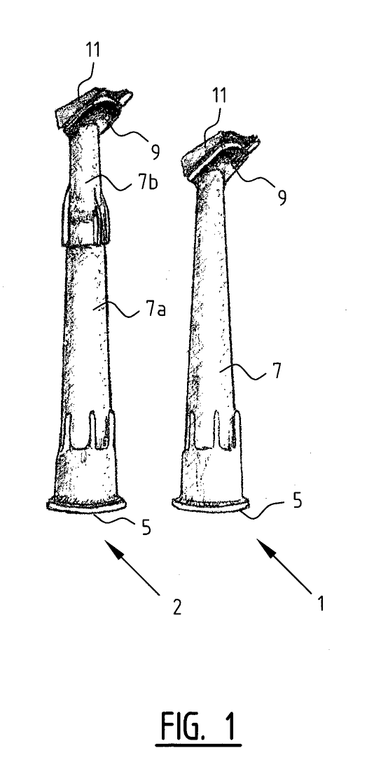

FIG. 1 shows two embodiments of the applicator according to the invention;

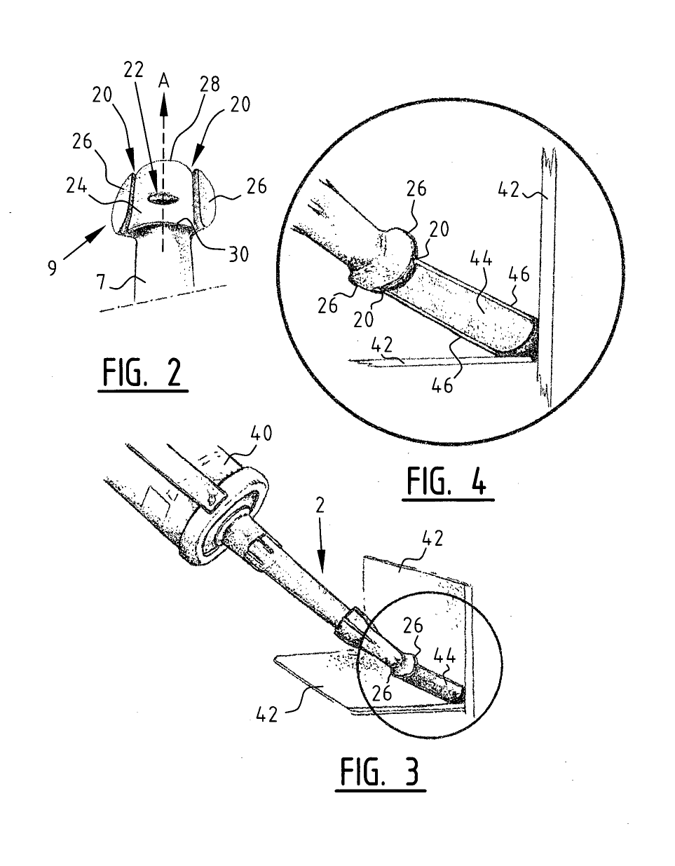

FIG. 2 shows in detail the wiping blade of the applicator of FIG. 1;

FIG. 3 shows the use of the applicator for applying a joint;

FIG. 4 shows in detail a joint applied with the applicator;

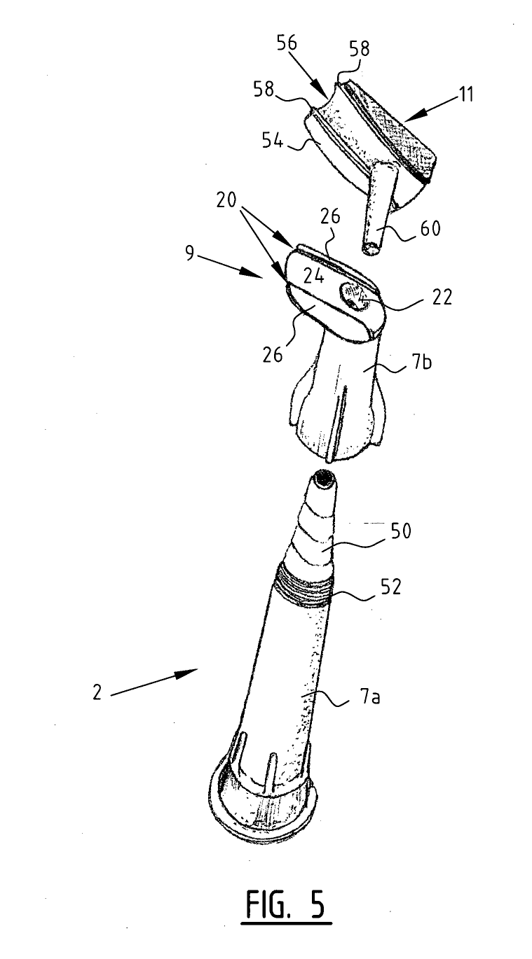

FIG. 5 shows the separate components according to a special embodiment of the applicator;

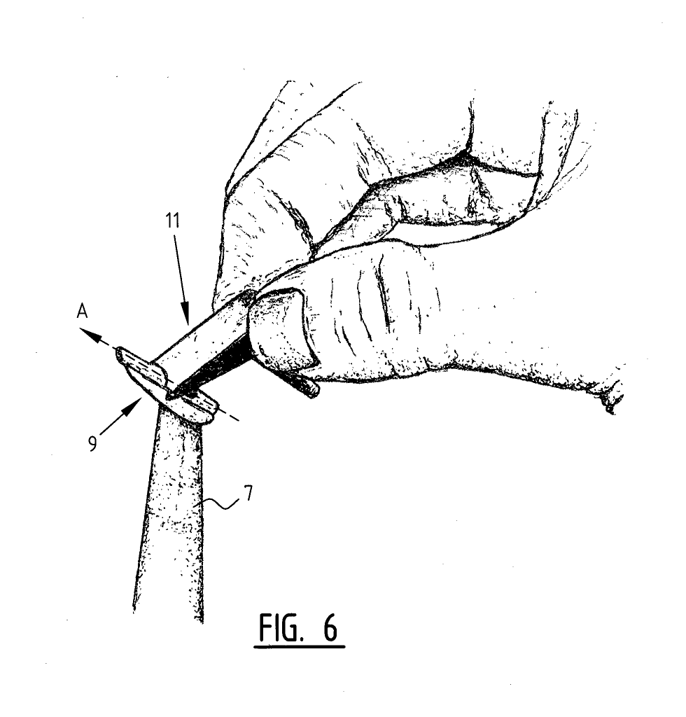

FIG. 6 shows the use of the protective cap for cleaning the wiping blade;

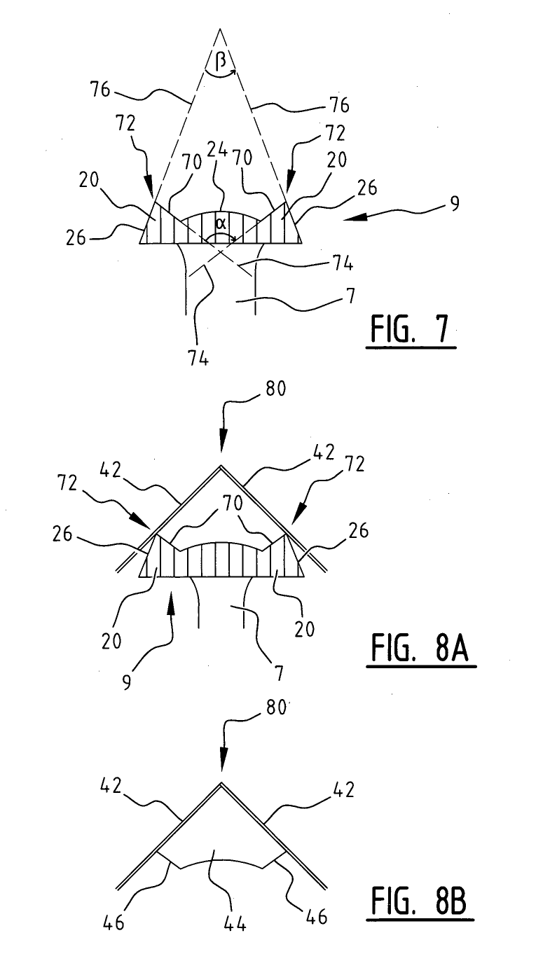

FIG. 7 shows a preferred embodiment of the profile of the wiping blade in cross-section perpendicularly of the longitudinal direction and at the position of the wiping edge;

FIG. 8a shows the profile of the wiping blade of FIG. 7 as it is oriented during use at a joint line and makes contact with walls adjacent to the joint line.

FIG. 8b shows a joint arranged on the basis of the situation of FIG. 8a.

FIG. 1 shows two versions of an applicator 1 and an applicator 2 according to the invention. Applicator 1 is constructed from a supply side 5, a feed tube 7 and a wiping blade 9 on which a protective cap 11 is arranged. Applicator 2 is constructed from the same components, wherein the feed tube is embodied as a two-part assembly. The assembly consists of a first part 7a and a second part 7b embodied for release from each other.

FIG. 2 shows the upper surface of wiping blade 9 which is fixedly connected to feed tube 7. The wiping blade has a longitudinal direction indicated with broken line A. Present on the upper surface are two dikes 20 which extend in longitudinal direction A and are arranged on either side of nozzle 22. Between the two dikes 20 is an inner surface 24. Each of the dikes 20 has an outer wall 26. The inner surface 24 between the dikes has a wiping edge 28 and a collecting edge 30. The arrow connected to broken line A indicates the direction in which sealant flows out of nozzle 22 to wiping edge 28. In the plane of the wiping blade the wiping edge has a curved form, this making it especially suitable for applying joints along a curved line, as is for instance necessary in the case of sanitary ware mounted on a wall.

FIG. 3 shows the use of applicator 2, wherein it is connected to a container with sealant 40 by means of a screw thread coupling (not shown). The wiping blade of applicator 2 is directed at the joint line between the two walls 42. Sealant is meanwhile pressed out of the container while applicator 2 is moved to the left so that a joint of sealant 44 is arranged in the joint line between the two walls 42.

FIG. 4 is a detail of FIG. 3, and shows that the longitudinal edges 46 of the joint of sealant 44 extend away from walls 42 and are of some thickness. This is directly related to the profile of the wiping edge of the applicator along which the sealant is applied to and wiped on the joint line.

FIG. 5 shows a structure of an applicator 2 of FIG. 1. The first part of feed tube 7a is provided on the top side with a tapering outer end 50 which can make a clamp coupling with the second part 7b of the feed tube. A screw thread 52 is provided which can couple to an internal screw thread (not shown) of tube 7b. Tube 7b is provided with a wiping blade 9 with an inner surface 24, dikes 20 with outer walls 26 and a nozzle 22. Protective cap 11 has a flat side 54 with a profile complementary to the upper surface of wiping blade 9. A pin 60 connected fixedly to the protective cap can be inserted into nozzle 22 so that the protective cap can be placed in fixed position on the wiping blade. An edge 56 of protective cap 11 has a profile complementary to the profile of the upper surface of the wiping blade in cross-section perpendicularly of the longitudinal direction of the wiping blade.

FIG. 6 shows how protective cap 11 can be placed on the upper surface of wiping blade 9 in order to thus scrape the upper surface clean. Also shown is the tilted position in the longitudinal direction A of wiping blade 9 relative to feed tube 7.

FIG. 7 shows schematically and in detail the profile of the wiping edge of wiping blade 9 as shown in FIG. 2, as seen in cross-section perpendicularly of the longitudinal direction. The same components referred to in FIG. 2 are shown with the same reference numerals. The upper surface of wiping blade 9 comprises two dikes 20 between which the inner surface 24 is present which has a convex form. Each dike 20 is constructed from an outer wall 26, an inner wall 70 and a top part 72 having a sharp tipped form. Two tangents 74 to inner walls 70 lie at an angle α of about 120 degrees relative to each other. Two tangents 76 to outer walls 26 lie at an angle β of about 60 degrees relative to each other.

When angle α is more than 0 degrees and less than 180 degrees, inner walls 70 then have a diverging orientation relative to each other.

When angle β is more than 0 degrees and less than 180 degrees, outer walls 70 then have a converging orientation relative to each other.

These definitions of diverging and converging orientation of inner wall and outer wall apply in general sense to this description and the appended claims, and not only in respect of the figure description.

FIG. 8a shows the profile of the wiping edge of wiping blade 9 of FIG. 7 wherein it is directed at a joint line 80, and top parts 72 of dikes 20 make contact with the adjacent walls 42 lying at an angle of 90 degrees to each other. Because angle β is about 60 degrees, the outer walls remain clear of contact with the adjacent walls 42. The contact surface between the wiping blade and walls 42 is thus limited to the tipped top parts 72 of the dikes, thereby ensuring a relatively high contact pressure between wiping blade 9 and walls 42. Because angle α is about 120 degrees, inner walls 70 are directed somewhat obliquely of the adjacent walls, i.e. not exactly perpendicularly. A perpendicular position of the longitudinal edges would be obtained at an angle α of 90 degrees.

FIG. 8b shows a joint 44 obtained after sealant has been applied, on the basis of the situation of FIG. 8a, from the profile of the wiping edge to joint line 80. The longitudinal edges 46 extending away from the surfaces on which the joint is arranged are at a slight angle to the adjacent walls 42, this being found to be an optimal position in practice for obtaining a robust and durable longitudinal edge 46 of joint 44.

1. Applicator for sealants, comprising
a feed tube with a supply side, a tubular feed part and an outflow side, wherein the outflow side comprises a nozzle;
a wiping blade fixedly connected to the outflow side of the feed tube, wherein the periphery of the nozzle is located in the upper surface of the wiping blade and wherein the upper surface of the wiping blade has a profile formed from:
an inner surface bounded by two dikes, wherein these dikes are raised relative to the inner surface and extend at a distance from each other in the longitudinal direction of the wiping blade, wherein the nozzle is located between the two dikes and in the inner surface,
wherein the dikes and the inner surface extend to an edge of the wiping blade where the profile of the inner surface and the dikes together form a wiping edge for applying and wiping sealant on an object,
wherein the wall of the dikes standing on the inner surface is defined as inner wall, and wherein the inner walls of the dikes have a diverging orientation relative to each other at least at the position of the wiping edge in a cross-sectional view perpendicularly of the longitudinal direction of the wiping blade, and
wherein each of the two dikes comprises an inner wall and an outer wall, wherein the outer walls of the dikes have a converging orientation relative to each other in a cross-sectional view perpendicularly of the longitudinal direction of the wiping blade.

2. Applicator as claimed in claim 1, wherein tangents to the inner walls of the two dikes, in a cross-sectional view perpendicularly of the longitudinal direction of the wiping blade, lie at an angle relative to each other of 45 degrees to 135 degrees, preferably an angle of 90 degrees to 135 degrees.

3. Applicator as claimed in claim 1, wherein each of the two dikes comprises an inner wall and an outer wall, wherein the outer wall and inner wall connect to each other at a tipped top part, wherein if desired the tipped top part has a sharp, truncated or rounded tip form.

4. (canceled)

5. Applicator as claimed in claim 1, wherein tangents to the outer walls of the two dikes, in a cross-sectional view perpendicularly of the longitudinal direction of the wiping blade, lie at an angle relative to each other of 90 degrees or less, preferably an angle of 70 degrees or less.

6. Applicator as claimed in claim 1, wherein the inner surface of the wiping blade has, at least at the position of the wiping edge, a convex form in a cross-sectional view perpendicularly of the longitudinal direction of the wiping blade.

7. Applicator as claimed in claim 1, wherein the dikes extend as far as the second edge of the wiping blade, this second edge forming a collecting edge for collecting excess sealant.

8. Applicator as claimed in claim 1, wherein the upper surface of the wiping blade lies in a tilted position relative to the feed tube, preferably at an angle of 20 to 70 degrees.

9. Applicator as claimed in claim 1, wherein the feed tube is embodied as a releasable assembly of two parts, wherein the first part comprises the supply side and the second part the outflow side.

10. Applicator as claimed in claim 1, provided with a removable protective cap for the wiping blade consisting of a planar body having on a flat side a profile complementary to the profile of the upper surface of the wiping blade, wherein the profile of the protective cap is placed fitting onto the profile of the wiping blade.

11. Applicator as claimed in claim 10, wherein the protective cap comprises an edge with a profile complementary to the profile of the upper surface of the wiping blade in a cross-section perpendicularly of the longitudinal direction of the wiping blade.

12. Applicator as claimed in claim 10, wherein connected to the flat side with profile of the protective cap is a pin which, when placed on the wiping blade, fits into the nozzle.

13. Method for combined applying and wiping of sealant on an object, wherein the object is a joint line between two adjacent surfaces at an angle to each other, and wherein the sealant applied to the joint line forms a joint having upright longitudinal edges.

14. Method as claimed in claim 13, wherein the two adjacent surfaces between which the joint line is present are at an angle to each other of 45 to 135 degrees, preferably 60 to 120 degrees and most preferably 90 degrees.

15. Method as claimed in claim 13, wherein an applicator as claimed in claim 1 is applied.
